(19) United States
(12) Patent Application Publication
(10) Pub. No.: US 2023/0263256 A1
(43) Pub. Date: Aug. 24, 2023

(54) SNOW SPORT HELMET EVALUATION SYSTEM

(71) Applicant: VIRGINIA TECH INTELLECTUAL PROPERTIES, INC., Blacksburg, VA (US)

(72) Inventors: Steve Rowson, Blacksburg, VA (US); Mark Begonia, Christianburg, VA (US); Stefan Duma, Blacksburg, VA (US)

(21) Appl. No.: 18/172,127

(22) Filed: Feb. 21, 2023

Related U.S. Application Data
(60) Provisional application No. 63/312,214, filed on Feb. 21, 2022.

(51) Int. Cl. A42B 3/04

(52) U.S. Cl. CPC A42B 3/046

(57) ABSTRACT

Various embodiments relating to methods for evaluating injury mitigation performance of helmets that are used for snow sports (e.g., skiing or snowboarding) are described. In one embodiment, a method for evaluating injury mitigation performance of a helmet includes applying a first and a second impact configuration to a helmet. The first and the second impact configurations include a plurality of impacts between the helmet and a metal plate. The metal plate is tilted at a first predetermined angle for the first impact configuration and at a second predetermined angle for the second impact configuration. The method further includes generating acceleration and velocity data based on impacts that occur as part of the two impact configurations. The method further includes determining injury risk values based on the generated acceleration and velocity data. The method also includes determining an overall injury risk metric based on the injury risk values and exposure values.

### CROSS REFERENCE TO RELATED APPLICATIONS

This application claims the benefit of and priority to U.S. Provisional Application Serial No. 63/312/214, filed Feb. 21, 2022, titled “SNOW SPORT HELMET EVALUATION SYSTEM,” the entire contents of which are hereby incorporated herein by reference.

### BACKGROUND

Head injury is an inevitable risk in snow sports or winter sports. In snow sports such as skiing, snowboarding, or sledding, concussions account for a significant portion of the injuries. Athletes who engage in snow sports often trek down slopes or on uneven terrain, which can increase the likelihood of a fall occurring. Wearing a properly fitted helmet while engaging in snow sports may prevent or reduce the severity of head injuries or concussions resulting from such falls. Poorly designed headgear may be insufficient in providing protection against concussions and can often give players a false sense of security while playing.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 illustrates a cross sectional view of an example headform that can be used for impact testing of helmets in accordance with various embodiments of the present disclosure.

FIG. 2 illustrates an adapter that can be used to connect the example headform shown in FIG. 1 to a neck structure in accordance with various embodiments of the present disclosure.

FIG. 3 illustrates a side view of the example headform shown in FIG. 1 with the adapter secured to the example headform in accordance with various embodiments of the present disclosure.

FIG. 4 illustrates a drop tower testing apparatus in a resting position in accordance with various embodiments of the present disclosure.

FIGS. 5A-5C illustrate close-up views of impacts occurring between locations of a helmet positioned on the example headform shown in FIG. 1 and a metal plate in accordance with various embodiments of the present disclosure.

FIG. 6 is a flowchart illustrating exemplary steps of a method to evaluate concussion mitigation performance of helmets in accordance with various embodiments of the present disclosure.

### DETAILED DESCRIPTION

Aspects of the present disclosure relate to methods for evaluating injury mitigation performance of helmets that are used for snow sports or winter sports (e.g., skiing, snowboarding, etc.). Current snow sport evaluation standards are similar to many historical helmet evaluation standards and typically evaluate only a linear acceleration component. However, both linear and angular components of velocity and acceleration occur during head impacts, and it is important to evaluate angular velocity relative to brain injuries as part of impact testing of helmets. A helmet that lowers both linear acceleration and angular velocity can reduce the risk of brain injury risk in real-world head impact events. Given the serious head injuries observed in snow sports, both linear acceleration and angular velocity measures should be analyzed when evaluating the biomechanical performance of helmets for snow sports.

According to various embodiments, a testing method can measure or evaluate the overall risk injury and concussion mitigation performance of helmets used for snow sports or other activities. The method is referenced herein as a Summation of Tests for the Analysis of Risk (STAR) method in some examples, but variations of the method can be practiced based on the concepts described herein, regardless of the use of any shorthand names. Although the embodiments of the present disclosure will discuss the STAR method with reference to snow sport helmets, any suitable helmet used for snow sports or similar activities may be evaluated using the STAR method described herein.

The method described herein combines impact testing of helmets with an overall injury risk function as well as injury risk values and exposure values to generate a summary of helmet performance. Impact testing of helmets may be carried out with use of a drop tower testing apparatus that allows free fall of various dummy headforms onto an adjustable metal plate in one example. A dummy headform and helmet is secured to a support ring of the drop tower. For example, one such configuration can include a snow sport helmet positioned on a NOCSAE® headform that is secured to the support ring with adjustable rods and a lever arm, although other types of headforms can be relied upon. The headform is secured to the support ring in the drop tower testing apparatus. By operation of the drop tower, the drop tower is configured to impact the helmet and headform against the adjustable metal plate, where the adjustable metal plate is tilted at predetermined angle. This corresponds to one example impact configuration, and other impact configurations involving dummy headforms and other supporting mechanisms and metal plates may be used for impact testing without departing from the spirit and scope of the embodiments presented herein.

Instrumentation can be positioned within the headform that measures linear acceleration, angular velocity, angular acceleration, and other inertial measurements. In some cases, angular acceleration may be determined from measured angular velocity. Impact tests can be performed at a range of impact locations and energy levels that include both centric and non-centric impact configurations, which can impact the evaluation of concussion mitigation performance. For each impact test, the peak linear acceleration and angular velocity values are inserted into a brain injury risk function, and the values from the brain injury risk function can be multiplied by an exposure value to obtain a weighted risk value.

The weighted risk values from the impact tests can be further evaluated using a function or equation. The function or equation aggregates the data from the impact tests into an overall injury risk metric or number, as a score representative of the performance of helmets. The score can then be used to categorize helmets into a rating system that includes numerical ranges (e.g., 1-5). Helmets with higher ratings do a better job of managing impact energy and ultimately lowering the linear acceleration and rotational velocity values the head would experience for a given impact, although other rating scales can be relied upon. The rating system can differentiate complex helmet performance into usable information for consumers. On-field studies have shown brain injury reduction rates in athletes who wear higher rated helmets.

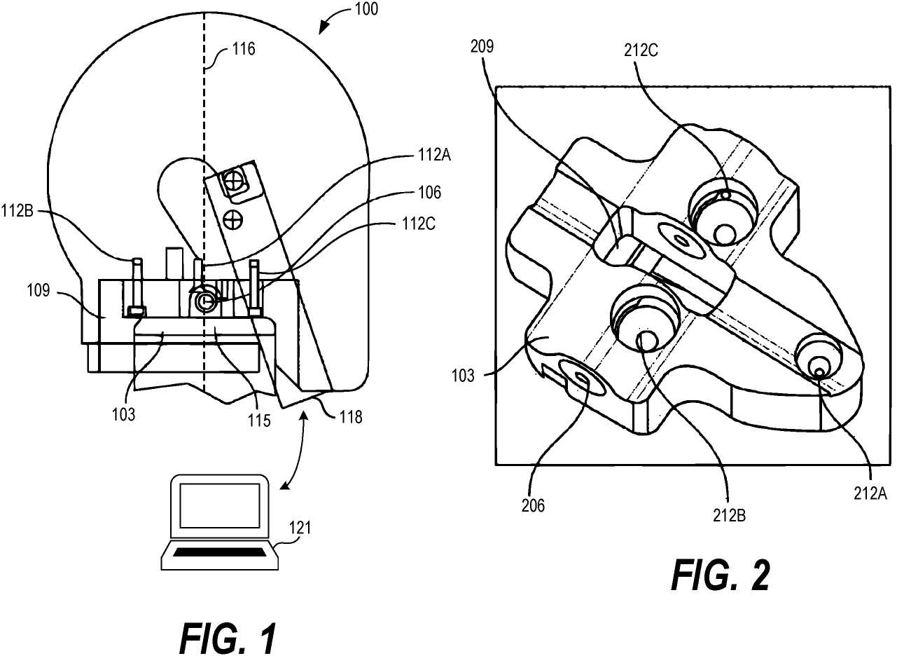

Turning to the drawings, FIG. 1 shows a cross sectional view of a headform 100 that can be used for impact testing of helmets (e.g., snow sport helmets) used for contact sports or other activities according to the methods described herein. In this example shown, the headform 100 includes an opening 109 in a lower region (toward the chin of the headform 100), a sensor package 118, fasteners 112A-112C, an occipital condyle pin 106, and an adapter 103. In some embodiments of the headform 100, the fasteners 112A-112C, the occipital condyle pin 106, and the adapter 103 may not be present.

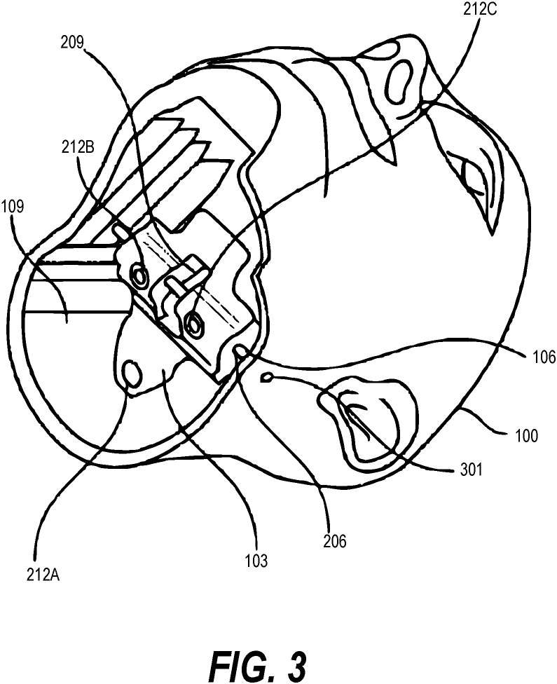

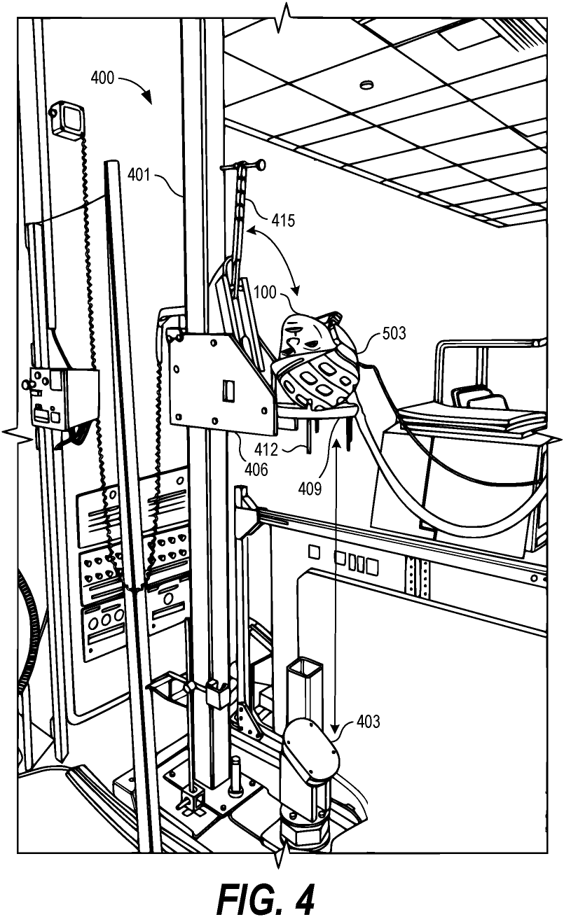

FIG. 1 also illustrates a portion of a neck 115 that can attach to the headform 100 through the adapter 103 at the opening 109. The adapter 103 can be used to mount the headform 100 to the neck 115. In this respect, the adapter 103 can include a custom adapter plate that provides anatomically accurate relative locations of the occipital condyle pin 106 and center of gravity 116 of the headform 100. In some embodiments, the headform 100 and the neck 115 can include a NOCSAE® headform and a Hybrid III 50^{th} percentile neck, respectively. However, the neck 115 may not be needed to conduct the impact tests discussed herein with respect to the testing of snow sport helmets. That is, the embodiments described herein do not necessarily rely upon the adapter 103 to mechanically couple the headform 100 to the neck 115, and it is not necessary to couple the headform 100 to the neck 115 when using the drop tower testing apparatus shown in FIG. 4 and described below. Further, other dummy headforms other than the NOCSAE® headform may be used to conduct the impact tests discussed herein. A detailed view of the adapter 103 is illustrated in FIG. 2. A side view of the headform 100 with the attached adapter 103 is illustrated in FIG. 3.

The adapter 103 can include mounting holes 212A-212C, which can receive fasteners 112A-112C located within the headform 100, to secure the headform 100 to the adapter 103. As such, the adapter 103 can improve the anatomical accuracy of the location of the center of gravity 116 of the headform 100. A bore 206 in the adapter 103 and opening 301 (shown in FIG. 3) in the headform 100 can be matched to receive the occipital condyle pin 106. An opening 209 in the adapter 103 can be used to connect the neck 115 to the headform 100. The headform 100 can include various types of dummy headforms, such as the NOCSAE® headform, that are suitable for fitting helmets. The neck 115 can include various types of dummy necks, such as the Hybrid III 50^{th} percentile male neck, that can be attached to the headform 100 and is suitable for impact testing of helmets.

The sensor package 118 can be attached near the center of gravity 116 of the headform 100. The sensor package 118 can include multiple accelerometers, angular rate sensors, or other inertial measurement or sensor units that measure linear acceleration, angular velocity, angular acceleration, and other inertial metrics generated by head impacts during testing of helmets, such as snow sport helmets. In some embodiments, the sensor package 118 can include a six degree of freedom (6DoF) sensor package that includes three accelerometers and a triaxial angular rate sensor. However, other quantities and combinations of linear accelerometers, angular accelerometers, and angular rate sensors can be employed within the headform 100 to measure linear acceleration, angular velocity, and/or angular acceleration. In some cases, angular acceleration values may be determined based on the obtained angular velocity data.

The sensor package 118 can be embodied as one or more accelerometers. As one example, the sensor package 118 is capable of measuring acceleration (i.e., the rate of change of velocity) as compared to its own instantaneous rest frame and provide feedback signals or data representative of the acceleration. The accelerometers of the sensor package 118 can be single or multi-axis accelerometers, capable of detecting both the magnitude and the direction of the acceleration in some cases, as a vector quantity. In some cases, the sensor package 118 can be an inertial measurement unit (IMU) capable of also measuring orientation, positional angular information, velocity, and other inertial information related to the headform 100. Thus, the sensor package 118 can also sense orientation, coordinate acceleration, vibration, shock, and falling motions in some cases. Examples of the accelerometers of the sensor package 118 can include accelerometers from Endevco®, Piezotronics®, Dytran®, Honeywell®, Bosch®, and other manufacturers.

The sensor package 118 can be communicatively coupled with computing device 121 for data transfer using any suitable wired or wireless interface. The computing device 121 can include one or more processing circuits, for example, having processors and memories or memory devices, which can be coupled to a local interface for data communication. The processing circuits of the computing device 121 can process data, as described herein, such as linear acceleration data, angular velocity data, angular acceleration data, and other types of data. In some cases, the computing device 121 can include data sampling, filtering, and processing devices or systems, for processing data from the sensor package 118. The computing device 121 can also include power sources, such as batteries or other power sources. The local interfaces of the computing device 121 can be embodied as wired, wireless, or wired and wireless local interfaces. The sensor package 118 may communicate with the computing device 121 through one or more wired, WiFi, Bluetooth®, near-field communication (NFC), wireless infrared, ultra-wideband, wireless induction, long range (LoRa), Z-Wave®, ZigBee®, etc., interfaces.

FIG. 4 illustrates a drop tower testing apparatus 400 that can be used to conduct impact testing of an example helmet 503 on the headform 100 according to one or more embodiments. As discussed previously, the testing methods described herein incorporate impact testing of helmets and use of an overall injury risk function to analyze linear acceleration and rotational velocity values resulting from the impact tests. The drop tower testing apparatus 400 (“drop tower 400”) includes a vertical beam 401, a carriage device 406, a support ring 409, and a lever arm 415. The drop tower 400 can be controlled by a winch system equipped with an electromagnet attached to the carriage device 406. The winch system is configured to raise the carriage device 406 to various heights. The electromagnet is configured to secure the carriage device 406 at a particular height. Once the electromagnet is released, the carriage device 406 is configured to drop or free fall towards an adjustable metal plate 403 (“metal plate 403”) based on a gravitational pull. The drop tower 400 can be used to conduct the impact testing portion of the testing methods. Use of the drop tower 400 is beneficial in that it enables an easily repeatable system to conduct the impact tests. As shown, FIG. 4 illustrates the drop tower 400 in a resting position at a predetermined height before activation.

In some cases, the winch system may be pneumatically or hydraulicly driven. Other drop tower testing apparatuses and related impact testing tools can be relied upon to gather impact data for evaluation using the concussion risk functions described herein.

In addition, components of the drop tower 400 may be controlled or directed, at least in part, by the computing device 121. For example, the computing device 121 may be in data communication with the winch system to control the height and velocity at which the carriage device 406 and the headform 100 falls using electromechanical actuators, switches, motors, and other systems. The drop tower 400 may communicate with the computing device 121 through one or more wired, WiFi, Bluetooth®, NFC, wireless infrared, ultra-wideband, wireless induction, long range (LoRa), Z-Wave®, ZigBee®, etc., interfaces.

In order to carry out the impact tests, the helmet 503 is first positioned on the headform 100. As discussed previously, the headform 100 can include a NOCSAE® headform in one example, although other types of headforms can be relied upon. The headform 100 is then secured to the support ring 409 in an inverted position with adjustable rods 412 that are distributed around the support ring 409. The adjustable rods 412 include rubber tips in one example (see FIG. 3), and the positions or heights of each of the adjustable rods 412 can be separately set. Thus, the adjustable rods 412 can be used to position the headform 100 into a desired orientation or position over the support ring 409, enabling impact to any point on the helmet 503. According to one example, the position of the headform 100, with the helmet 503 fitted over the headform 100, can be confirmed using a dual-axis inclinometer mounted on a custom holder that fits inside an instrumentation channel of the headform 100, which can measure X and Y angles relative to gravity. The adjustable rods 412 can be adjusted as needed to obtain the desired orientation of the headform 100 and helmet 503 before a drop is performed for impact testing.

The support ring 409 is attached to the carriage device 406. The headform 100 is positioned over the support ring 409 and additionally secured to or down upon the support ring 409 with the lever arm 415. The lever arm 415 is configured to rotate down and contact a bottom portion of the headform, so that the headform 100 remains stable in the desired position over the support ring 409 during falls for impact testing. Upon activation or release of the carriage device 406 from a predetermined height, the carriage device 406 falls along or slides down the vertical beam 401, carrying the support ring 409, the headform 100, and the helmet 503 down towards the metal plate 403 with simulated free fall characteristics. The computing device 121 can be configured to control the activation and timing of the release of the carriage device 406 in some cases. In other cases, the release of the carriage device 406 can be performed by one or more manual operations.

As the support ring 409, the headform 100, and the helmet 503 fall down toward the metal plate 403 with simulated free fall characteristics, only a portion of an outer surface of the helmet 503 will impact the metal plate 403. The carriage device 406, the support ring 409, and the adjustable rods 412 are positioned in an orientation that prevents impact with the metal plate 403. For example, the support ring 409 and the adjustable rods 412 pass around the outside of the metal plate 403 as the helmet 503 impacts the metal plate 403 according to one example. As such, the accuracy of the impact tests is increased. As the helmet 503 reaches the metal plate 403, the lever arm 415 is configured to release or detach from the headform 100 at a time before the helmet 503 impacts the metal plate 403, thus enabling the helmet 503 and the headform 100 to be unconstrained during impact. The computing device 121 can be configured to control the release timing of the lever arm 415 based on a particular location of the carriage device 406 along the vertical beam 401, an amount of elapsed time from release of the carriage device 406 for free fall, or other criteria.

The metal plate 403 is secured in place and can include smooth metal planes or anvils according to certain examples. The metal plate 403 includes a smooth surface in one example that simulates frictionless conditions of snow and ice. The metal plate 403 is tilted in an orientation with a predetermined tilt angle θ. The tilt angle θ can be selected based on uneven terrain characteristics of surfaces prevalent in snow sports in one example, although the tilt angle θ can be selected based on other characteristics for other activities. In one example, the tilt angle θ of the metal plate 403 can be adjusted to 35° or 55° to replicate a higher normal velocity component or a higher tangential velocity component, respectively, resulting from the impact tests. Other ranges of the tilt angle θ can be relied upon, such as tilt angles θ in a range between 25° and 65°, and the metal plate 403 may be adjustable over a full range of tilt angles θ between 0° and 90° depending on the design of the drop tower testing apparatus 400.

In some cases, the height at which the carriage device 406 rises to, the tilt angle θ of the metal plate 403, and the release timing of the lever arm 415 may be controlled by the computing device 121, allowing for automated control of the drop tower 400 and the metal plate 403 based on control of a user interface of the computing device 121. In some cases, the drop tower 400 may be manually configured, at least in part, by a user (e.g., user who controls the winch system). When the helmet 503 impacts the metal plate 403, linear and rotational kinematics are generated and collected by the sensor package 188 for evaluation by the computing device 121 using the injury risk function discussed herein.

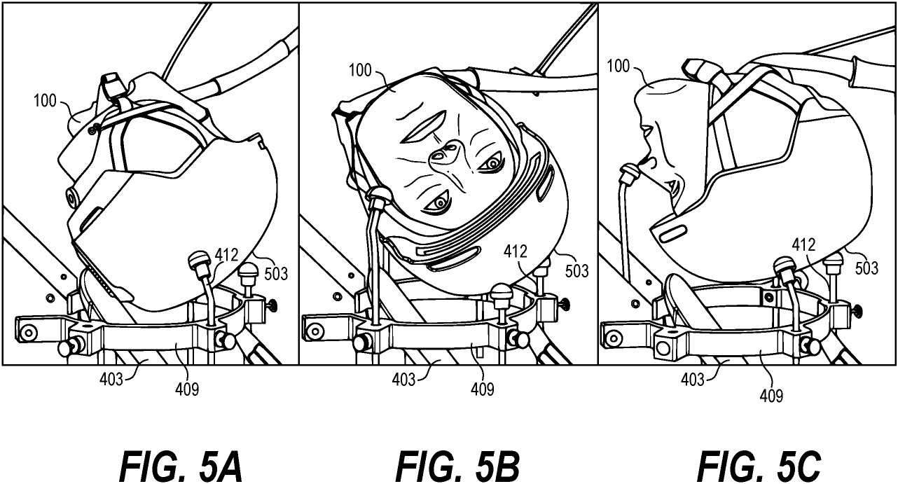

FIGS. 5A-5C illustrate various views of different locations of the helmet 503 impacting the metal plate 403. FIG. 5A illustrates a rear boss of the helmet 503 impacting the metal plate 403, FIG. 5B illustrates a side of the helmet 503 impacting the metal plate 403, and FIG. 5C illustrates a front of the helmet 503 impacting the metal plate 403. The rear boss location of the helmet 503 refers to a location between the rear of the helmet 503 and a side of the helmet 503. The helmet 503 can include any helmet, including those used for snow sports or related activities.

The methods described herein rely upon impact tests conducted at multiple locations on the helmet 503. In one embodiment, two or more impact configurations can be used to test the model of the helmet 503 for a total of twelve impact tests. A first impact configuration can be defined as impacts with one resultant velocity at the three aforementioned impact locations of the helmet 503, at a first tilt angle θ of the metal plate 403. A second impact configuration can be defined as impacts with the same resultant velocity at the three aforementioned impact locations of the helmet 503, at a second tilt angle θ of the metal plate 403. The resultant velocity can be selected based on real-world head impact data and current testing standards. The resultant velocity can be set or determined based on the drop height of the carriage device 406. Each impact test in the first and the second impact configurations can be repeated to produce a total of twelve impact tests according to one example.

The tilt angle of the metal plate 403 is adjustable by the user but was selected as 35° for the first impact configuration and 55° for the second impact configuration according to one example. Adjusting the tilt angle of the metal plate 403 can generate varying amounts of normal and tangential incident velocities upon impacts with the helmet 503. For example, the tilt angle of 35° was selected to generate impacts with a lower normal component and a higher tangential component of velocity. The tilt angle of 55° was selected to generate impacts with a lower tangential component and a higher normal component of velocity.

To generate accurate test results, each impact location of the helmet 503 is impacted a same number of times. That is, applying the two impact configurations to the helmet 503 can require at least six impacts (i.e., three impacts at a first impact velocity and a first tilt angle of the metal plate 403 and another three impacts at the first impact velocity and a second tilt angle of the metal plate 403). Thus, the helmet 503 can be impacted at the aforementioned three locations a same number of times with the metal plate 403, but at different tilt angles of the metal plate 403.

As explained above, each impact location of the helmet 503 may be impacted more than once to generate more sample data. Generating more sample data may improve the reproducibility of the tests and improve accuracy, although at the cost of some deformation to the helmet 503 caused by testing. For example, each of the two impact configurations may be repeated so that each impact location is impacted twice during the tests. Repeating the two impact configurations for a total of two impacts at each location of the helmet 503 can result in approximately 12 impact tests per helmet model.

In another example, the two impact configurations may be applied to a separate sample of a same model helmet as the helmet 503. For instance, a second helmet of the same model as the helmet 503 may be used for testing, and each of the two impact configurations at the three locations can be applied to the second helmet. Additionally, the two impact configurations may be repeated on the second helmet similar to the impact tests of the first helmet. In such a scenario, an additional 12 tests may be carried out for the second sample to generate a total of 24 tests between the first helmet and the second helmet.

When the helmet 503 impacts the metal plate 403 at each of the above-mentioned impact locations, resultant linear acceleration and angular velocity measurements are generated by the sensor package 118 based on translations and rotations of the headform 100. The peak resultant linear acceleration and angular velocity measurements that are generated by the sensor package 118 are used to determine an injury risk value for each impact. The injury risk values are then used to determine a an overall injury risk metric for the helmet 503.

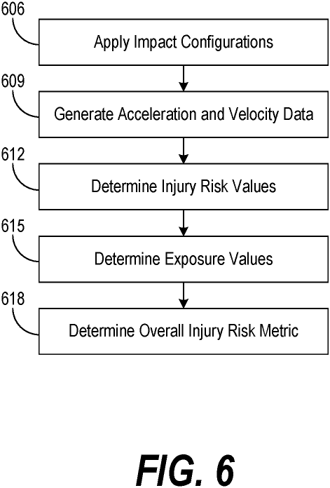

In some cases, each impact configuration may include fewer or greater than three impacts, each performed at a different location on the helmet 503. Additionally, fewer or greater than two impact configurations may be used to conduct impact testing of the helmet 503. Thus, any one of the three aforementioned impact locations may or may not be impacted, and a second helmet of the same model as the helmet 503 may or may not be used. In some cases, more than two helmets of the same model may be tested. In any case, each impact location being impacted an equal number of times is an important consideration that is factored in when applying the overall injury risk function, which will be discussed in detail in the following paragraphs with respect to the flowchart shown in FIG. 6.

FIG. 6 is a flowchart outlining the steps of a method for evaluating the concussion mitigation performance of helmets used in snow sports or similar activities. At step 606, the method includes applying one or more impact configuration to a helmet selected for testing. For example, referring back to FIG. 4, the helmet 503 is selected for testing of concussion mitigation performance. The helmet 503, which can include various snow sport helmets, is positioned on the headform 100 based on the helmet manufacturer’s fitting guidelines. Chinstrap and laces (if applicable) are tightened for best fit according to manufacturer instructions. The headform 100 is then secured to the support ring 409 of the drop tower 400 in an inverted position with the adjustable rods 412 and the lever arm 415. Upon release of the carriage device 406 from a predetermined height, the helmet 503 is configured to impact the metal plate 403 with simulated free fall characteristics at various impact locations of the helmet 503.

The impact configurations can include two or more impact configurations to the helmet 503. For example, each of the first and the second impact configurations can include impacts between the front, the side, and the rear boss of the helmet 503 and the metal plate 403. For the first impact configuration, the helmet 503 can impact the metal plate 403 that has a tilt angle θ, at a first impact velocity. For the second impact configuration, the tilt angle θ of the metal plate 403 can be adjusted while keeping the other variables constant. To keep the impact velocity constant, the helmet 503 can be dropped with the carriage device 406 for both impact configurations at the same predetermined height with respect to the vertical beam 401. However, other locations of the helmet 503 may be impacted in some cases. In some cases, the drop tower 400 can be controlled by a winch system equipped with an electromagnet in order to raise and release the carriage device 406 at desired heights, which can result in a prescribed impact velocity being applied to the helmet 503. In some cases, the winch system may be pneumatically or hydraulicly driven. In some cases, the drop tower 400 may also be controlled by the computing device 121.

It may be beneficial in some cases to impact each impact location of the helmet 503 more than once to generate more sample data. Generating more sample data may improve reproducibility of the tests and improve accuracy of the sample data, although at the cost of some deformation to the helmet 503 caused by testing. For example, each of the two impact configurations may be repeated so that each impact location is impacted twice with respect to the two different tilt angles θ of the metal plate 403. Repeating the two impact configurations for a total of two impacts at each location of the helmet 503 can result in approximately 12 tests.

In another example, the two impact configurations (i.e., impacting the aforementioned three locations with respect to two different tilt angles θ of the metal plate 403) may be applied to a separate sample of a same model helmet as the helmet 503. For instance, a second helmet of the same model as the helmet 503 may be used additionally for testing, and each of the two impact configurations at the aforementioned three locations can be applied to the second helmet. Additionally, the two impact configurations may be repeated on the second helmet as well, so that an equal amount of data samples are generated for each of the two samples being tested. If each impact location is tested twice for the helmet 503 and the second helmet, a total of 24 tests may be conducted with 12 tests for each sample helmet.

Adjusting the tilt angle of the metal plate 403 can generate varying amounts of normal and tangential incident velocities upon impacts with the helmet 503. For example, the tilt angle of 35° was selected to generate impacts with a lower normal component and a higher tangential component of velocity in one case. The tilt angle of 55° was selected to generate impacts with a lower tangential component and a higher normal component. However, adjusting the tilt angle θ to a value other than 35° or 55° may be relied upon to generate impact velocities with lower or higher tangential and normal components as desired.

The table below details headform rotations of the headform 100 that can occur in the support ring 409 after each impact at the aforementioned three impact locations according to one example:

TABLE 1

Headform Translations for each Test Condition

| Configuration (Impact Location) | Anvil Angle (deg) | X (deg) | Y (deg) |
|---|---|---|---|
| 1 | 35 | -35 | 35 |
| 2 | 35 | 30 | -10 |
| 3 | 35 | 0 | -15 |
| 4 | 55 | -35 | 45 |
| 5 | 55 | 40 | -10 |
| 6 | 55 | 0 | -30 |

Impact locations 1-3 correspond to a rear boss of the helmet 503, a side of the helmet 503, and a front of the helmet 503, respectively. Impact locations 4-6 correspond to the same locations on the helmet 503 as the impact locations 1-3 but are assigned different numbers for injury risk calculation purposes due to the impacts occurring at a different anvil angle (55° vs 35°). Impact locations 1-3 with the anvil angle of 35° can correspond to the above-mentioned first impact configuration, and impact locations 4-6 with the anvil angle of 55° can correspond to the above-mentioned second impact configuration. Each of these impact locations are illustrated in FIGS. 5A-5C.

The X and Y rotations were determined using a dual axis inclinometer. The positive and negative signs correspond to SAE J211 coordinate system of the NOCSAE headform. Additionally, the table below details prescribed impact velocities used for impact testing for the two impact configurations, which were selected based on real-world head impact data and current testing standards.

TABLE 2

Prescribed Impact Velocities for each Impact Configuration

| Anvil Angle (deg) | Normal Velocity (m/s) | Tangential Velocity (m/s) | Resultant Velocity (m/s) |
|---|---|---|---|
| 35 | 5.5 | 3.8 | 6.7 |
| 55 | 3.8 | 5.5 | 6.7 |

At step 609, the method includes generating linear acceleration and angular velocity values associated with the first and the second impact configurations. As described herein, acceleration data can be generated by various accelerometers and sensors that can be positioned within a headform that is being used for impact testing. For example, the sensor package 118, which is positioned within the headform 100 near the center of gravity 116, may include accelerometers and angular rate sensors, among other IMUs. In one embodiment, the sensor package 118 includes a six degree of freedom (6DoF) sensor package that includes three accelerometers and a triaxial angular rate sensor. The three accelerometers can measure linear acceleration data, whereas the triaxial angular rate sensor may measure angular velocity data. In some embodiments, the sensor package 118 may also include angular accelerometers configured to measure angular acceleration, and also a different quantity of accelerometers and/or angular rate sensors. For each impact that occurs at the aforementioned impact locations, the sensor package 118 can generate linear acceleration data, angular velocity data, angular acceleration data, and other inertial measurement data. The computing device 121 may receive the generated data, including the acceleration data and angular velocity data, among other inertial measurement data, and process it as described herein. In cases where angular acceleration is not measured, the computing device 121 may determine the angular acceleration values based on differentiating the angular velocity data.

According to one example, the acceleration data and angular velocity data measured for each of the impacts listed in Table 1 were sampled at 20,000 Hz and filtered using a 4-pole Butterworth low pass filter according to SAE J211 (Instrumentation for Impact Test), with a cutoff frequency of 1650 Hz (CFC 1000) for the accelerometer data and 289 Hz (CFC 175) for the angular rate sensor data, by the computing device 121. The angular acceleration values were determined by differentiating the angular rate data by the computing device 121. Resultant values were calculated for linear acceleration (g) and angular velocity (rad/sec) by the computing device 121.

Moving to step 612, the method includes determining injury risk values associated with the first and the second impact configurations. Step 612 can include identifying a respective linear acceleration value and angular acceleration value for each impact of the first and the second impact configurations. The linear acceleration and angular velocity values generated in step 609 may be used to determine injury risk values by the computing device 121. For example, for each impact that occurs with respect to the first and the second impact configurations discussed in step 606, the computing device 121 is configured to calculate a risk value based on the following function or equation:

$$R \left(a , ω\right) = \frac{1}{1 + {e}^{- \left(- 10.2 \text{+} 0.0433 ∗ a + 0.19686 ∗ ω - 0.0002075 ∗ a ω\right)}} \qquad \text{(Eq. 1)}$$

This equation, also referenced herein as the injury risk function or concussion risk function, outputs a risk value R based on resultant linear acceleration (α) and resultant angular velocity (ω). The injury risk function includes use of both linear acceleration and angular velocity data because they are both correlated and predictive of concussion. Concussion risk is estimated based on an adaptation of a published multivariate logistic regression analysis of instrumented football player data paired with diagnosed concussions. This incorporates linear and rotational peak acceleration values, which are known to be associated with brain injury. The injury risk function in Equation 1 is based on a multivariate logistic regression analysis used to model risk as a function of both linear and angular head acceleration. To modify this risk function, an estimated linear relationship between rotational velocity and acceleration can be used to replace any rotational acceleration terms. Using the injury risk function enhances the data analysis by increasing the importance of higher acceleration impacts.

Moving to step 615, the method includes determining a plurality of exposure values associated with the first and the second impact configurations. For example, referring back to the example with the two impact configurations being applied to the helmet 503 in step 606, each impact location of the helmet 503 is configured to be impacted an equal number of times. The exposure values for each impact location are determined based on an optimization scheme to ensure that helmets are not under-designed in any one location. For instance, Table 3 lists exposure values used for each location/velocity combination.

TABLE 3

Exposure Values Used for each Location/Velocity Combination to Obtain Weighted Concussion Risk Values

| Configuration (Impact Location) | Exposure |
|---|---|
| 1 | 0.904 |
| 2 | 2.119 |
| 3 | 1.025 |
| 4 | 0.253 |
| 5 | 0.248 |
| 6 | 0.295 |

At step 618, the method includes determining an overall injury risk metric based on the plurality of injury risk values and the plurality of exposure values. For example, the computing device 121 can be configured to determine the overall injury risk metric for a helmet model based on the exposure values determined in step 615 and the concussion risk values determined in step 612. The concussion risk metric is determined based on the equation listed below:

$$S T A R = {\sum }_{L = 1}^{6} {\sum }_{V = 1}^{1} E \left(L , V\right) ∗ R \left(a , ω\right) , \qquad \text{(Eq. 2)}$$

where E represents exposure, L represents impact locations, V represents impact velocity, and R represents injury risk. With reference to the two impact configurations discussed in step 606, individual injury risk values for each of the impacts are multiplied by corresponding exposure values. The multiplied injury risk values and exposure values, also known as weighted risk values, are summed together to generate an overall score (e.g., a STAR score) for the helmet 503 being tested. In some embodiments, the computing device 121 may perform the steps 612-618 to determine the STAR score for a given helmet model.

The overall injury risk score for a given helmet model is then used to determine a corresponding rating, such as a STAR rating. The overall injury risk score is different from the rating. The rating may range up to five stars for the best available helmets in one example. The rating thresholds, such as STAR rating thresholds, are determined based on the average STAR scores of a tested helmet. For example, a STAR value of 0.5 represents a 50% reduction in risk of concussion relative to the average helmet, and then each subsequent rating threshold is set in increments of 50% more risk from the 5-star threshold.

TABLE 3

Thresholds to Match STAR Values to a STAR Rating

| STAR Value | Number of Stars |
|---|---|
| < 0.5 | 5 |
| < 0.75 | 4 |
| < 1 | 3 |
| < 1.25 | 2 |
| ≥ 1.25 | 1 |

The tested snow sport helmets should reduce the head impact accelerations to potentially reduce the number of head injuries in snow sports such as skiing or snowboarding. A limitation of the impacts discussed for the two impact configurations can be that that only one size of a helmet may be tested. Such testing conditions assume that performance is consistent throughout each size of helmet. However, there still could be deviation in performance as size increases or decreases due to potential changes in padding configuration and thickness. Accordingly, further embodiments of the present disclosure may include testing helmets of different sizes and/or weight, with the helmets being the same model. Additional embodiments may include testing helmets designated for different sexes (e.g., male or female) of the same model.

Many researchers have been using lab head impact data alongside computer models that simulate brain tissue strain. The linear and angular head acceleration and velocity data discussed herein may be utilized with computer models. This would allow for a better understanding of snow sport head injury response specifically in relation to brain deformation. Computer modeling has also been used in helmet research to design optimized helmet prototypes. These techniques could be applied to the snow sport head injury mechanisms to develop a helmet that is able to substantially reduce head injury risk.

The flowchart of FIG. 6 shows an exemplary implementation of the methods described herein, as applied to testing for concussion mitigation performance of helmets. Although the flowchart of FIG. 6 shows a specific order of execution, it is understood that the order of execution may differ from that which is depicted. For example, the order of execution of two or more blocks may be scrambled relative to the order shown. Also, two or more blocks shown in succession in FIG. 6 may be executed concurrently or with partial concurrence. Further, in some embodiments, one or more of the blocks shown in FIG. 6 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore at least the follwing is claimed:

1. A method of evaluating a helmet, comprising:
applying a first impact configuration to the helmet, the first impact configuration comprising a plurality of impacts between the helmet and a metal plate tilted at a first predetermined angle;
applying a second impact configuration to the helmet, the second impact configuration comprising a plurality of impacts between the helmet and the metal plate tilted at a second predetermined angle;
generating a plurality of linear acceleration and angular velocity values associated with the first and the second impact configurations;
determining a plurality of injury risk values associated with the first and the second impact configurations;
determining a plurality of exposure values associated with the first and the second impact configurations; and
determining an overall injury risk metric based on the plurality of injury risk values and the plurality of exposure values.

2. The method of claim 1, wherein:
the first impact configuration comprises a first impact between a front of the helmet and the metal plate, a second impact between a side of the helmet and the metal plate, and a third impact between a rear boss of the helmet and the metal plate; and
the second impact configuration comprises a fourth impact between the front of the helmet and the metal plate, a fifth impact between the side of the helmet and the metal plate, and a sixth impact between the rear of the helmet and the metal plate.

3. The method of claim 1, wherein identifying the plurality of linear acceleration and angular velocity values comprises identifying a respective linear acceleration value and angular acceleration value for each impact of the first and the second impact configurations.

4. The method of claim 1, wherein determining the plurality of injury risk values comprises determining a respective injury risk value for each impact of the first and the second impact configurations.

5. The method of claim 1, further comprising positioning the helmet on a headform, the headform being secured to a support ring in an inverted position.

6. The method of claim 5, wherein the support ring is secured to a carriage of an impact drop tower, the carriage comprising rollers and being configured to move up and down the impact drop tower.

7. The method of claim 6, further comprising releasing the carriage from a predetermined height to simulate a free fall of the helmet onto the metal plate and generate each impact of the first and the second impact configurations.

8. The method of claim 6, wherein the carriage comprises a lever arm that attaches to a bottom portion of the headform, the lever arm securing the headform to the support ring, the lever arm being configured to detach from the headform just prior to the helmet impacting the metal plate.

9. The method of claim 1, wherein the plurality of linear acceleration and angular velocity values are generated by a six degrees of freedom (6DoF) sensor package located near a center of gravity of a headform.

10. The method of claim 9, wherein the 6DoF sensor package comprises three accelerometers and a triaxial angular rate sensor.

11. The method of claim 1, wherein the metal plate comprises a surface that replicates a frictionless surface.

12. The method of claim 1, wherein the first impact configuration and the second impact configuration are applied with an equal impact velocity.

13. The method of claim 1, wherein the plurality of exposure values range from 0.2 to 2.5.

14. The method of claim 1, wherein determining the overall injury risk metric comprises:
multiplying an injury risk value among the plurality of injury risk values to a corresponding exposure value among the plurality of exposure values to determine a plurality of weighted injury risk values; and
aggregating the plurality of weighted injury risk values.

15. The method of claim 1, wherein each of the first and the second impact configurations comprises at least two impacts to each of the front, the side, and the rear boss of the helmet.

16. The method of claim 1, wherein the first predetermined angle and the second predetermined angle of the metal plate are adjustable.

17. The method of claim 1, wherein the first predetermined angle is 35° and the second predetermined angle is 55°.

18. The method of claim 1, wherein:
the first predetermined angle generates a lower normal component and a higher tangential component of impact velocity; and
the second predetermined angle generates a higher normal component and a lower tangential component of the impact velocity.

19. A method of evaluating a helmet, comprising:
applying a first impact configuration to the helmet, the first impact configuration comprising a plurality of impacts between the helmet and a metal plate tilted at a first predetermined angle;
applying a second impact configuration to the helmet, the second impact configuration comprising a plurality of impacts between the helmet and the metal plate tilted at a second predetermined angle;
generating a plurality of linear acceleration and angular velocity values associated with the first and the second impact configurations;
determining a plurality of injury risk values associated with the first and the second impact configurations; and
determining an overall injury risk metric based on the plurality of injury risk values.

20. The method of claim 19, wherein determining the overall injury risk metric comprises determining the overall injury risk metric based on the plurality of injury risk values and a plurality of exposure values.
